(19) United States
(12) Patent Application Publication
(10) Pub. No.: US 2026/0210364 A1
(43) Pub. Date: Jul. 23, 2026

(54) PUMP SYSTEM WITH ELECTRICALLY OPERATED COOLING DEVICE

(71) Applicant: Pfeiffer Vacuum Technology AG, Asslar (DE)

(72) Inventors: Michael SCHWEIGHOEFER, Schöffengrund (DE); Jan HOFMANN, Grünberg (DE); Maximilian BIRKENFELD, Bischoffen (DE)

(73) Assignee: Pfeiffer Vacuum Technology AG, Asslar (DE)

(21) Appl. No.: 19/410,348

(22) Filed: Dec. 5, 2025

(30) Foreign Application Priority Data
Dec. 5, 2024 (EP) 24217798

(51) Int. Cl. F04D 19/04; F04D 29/40; F04D 29/58

(52) U.S. Cl. CPC F04D 19/042; F04D 29/403; F04D 29/582

(57) ABSTRACT

A pump system includes a turbomolecular vacuum pump that has a housing having at least one pump inlet and one pump outlet; a first pump mechanism, driven by a rotor shaft, in the housing; and a second pump mechanism, downstream of the first pump mechanism and driven by the rotor shaft, in the housing. The second pump mechanism operates according to a different pumping principle than the first pump mechanism. For jointly conveying a process gas from the inlet to the outlet, the first and second pump mechanisms are arranged along the rotor shaft and are disposed in the axial direction between the inlet and the outlet. To cool the housing, the pump system also includes at least one electrically operated cooling device disposed in the axial direction with respect to the second pump mechanism on the side of the second pump mechanism that faces the first pump mechanism.

The present invention relates to a pump system comprising an electrically operated cooling device for cooling a turbomolecular vacuum pump of the pump system.

Turbomolecular vacuum pumps are usually used to generate a vacuum or a negative pressure in physical measurement devices such as mass spectrometers. In particular when evacuating mass spectrometers, it is in this respect often endeavored that the final pressure generated therein is in the ultra-high vacuum range, and thus in the range between 10⁻⁸ and 10⁻¹¹ mbar. To generate such low pressures, special turbomolecular vacuum pumps are often used that are inter alia characterized in that they have a plurality of turbomolecular pump stages which are connected behind one another in a technical flow aspect and which are each assigned their own pump inlet.

Such turbomolecular vacuum pumps comprising a plurality of pump inlets are generally known and are also designated as split-flow vacuum pumps. The terms “SplitFlow” and “SPLIT-FLOW” are registered trademarks of Pfeiffer Vacuum GmbH. Another name for such vacuum pumps is also multi-inlet vacuum pump.

However, it has been observed in the ultra-high vacuum range and above all at pressures lower than 10⁻⁹ mbar, in particular at pressures lower than 10⁻¹⁰ mbar, that undesirable physical phenomena occur that have a negative effect on the achievable final pressure. For example, desorption phenomena and/or permeation phenomena can in particular occur at pressures below 10⁻⁹ mbar, in particular at pressures below 10⁻¹⁰ mbar. The lower the pressure, the more these released gases in the ultra-high vacuum range represent an ever greater proportion of the total pressure. The final pressure to be achieved is hereby ultimately downwardly limited due to the physical phenomena described. This in turn limits the accuracy of physical measurement devices such as mass spectrometers.

Accordingly, it is the underlying object of the present invention to specify a pump system with which a lower pressure can be achieved compared to a pump system having the same pump configuration or compared to a pump system that has the same pump mechanism as the pump system according to the invention.

To satisfy this object, a pump system having a substantially conventional turbomolecular vacuum pump is presented, wherein the pump system is characterized by the features of claim 1.

A substantially conventional turbomolecular vacuum pump is characterized, among other things, in that it comprises a housing which has at least one pump inlet and one pump outlet and in which two pump mechanisms driven by a rotor shaft are located. A first of the two pump mechanisms is in this respect a turbomolecular pump stage that preferably comprises a plurality of rotor disks driven by the rotor shaft, whereas the second or the other pump mechanism of the two pump mechanisms is, for example, a Holweck pump stage that is located downstream of the first pump mechanism or downstream of the turbomolecular pump stage. In principle, the second or other pump mechanism works according to a different pumping principle than the first pump mechanism. In this regard, the second pump mechanism can, for example, also comprise a Siegbahn pump stage and/or a pump stage operating according to the side channel principle. For the joint conveying of a process gas from the pump inlet to the pump outlet, the two pump mechanisms are in this respect arranged in a conventional manner along the rotor shaft and are disposed in the axial direction between the at least one pump inlet and the pump outlet.

According to the invention, the pump system proposed here is now in particular characterized in that, for the cooling of the housing, it has at least one electrically operated cooling device that is located in the axial direction with respect to the second pump mechanism on the side of the second pump mechanism that faces the first pump mechanism. According to the invention, it was namely recognized that the mechanisms underlying the above-described desorption phenomena and/or permeation phenomena are temperature-dependent, among other things. It has in particular been observed that the proportion of gases that are released from a solid surface increases as the temperature increases.

In order thus to prevent the operation-induced heating of the turbomolecular vacuum pump, and thus the described gas desorption phenomena and/or gas permeation phenomena, according to the invention, it is therefore proposed for the first time to actively cool a turbomolecular vacuum pump in the region of the first pump mechanism between the pump inlet and the pump outlet.

It is indeed not unusual to cool the electric motor of a turbomolecular vacuum pump by means of a fan; however, the drive motor of conventional turbomolecular vacuum pumps is located with respect to the Holweck pump stage on the side of the Holweck pump stage that faces away from the turbomolecular pump stage, which consequently also applies to the fan for cooling the drive motor. The turbomolecular pump stage is therefore so-to-say spaced apart from the drive motor, and thus from the fan, by the Holweck pump stage so that the cooling of the drive motor has no or only a negligible effect on the turbomolecular pump stage. In this regard, a sufficient cooling of the turbomolecular pump stages at the high vacuum side cannot be ensured by the cooling of the drive motor.

According to the invention, it is therefore proposed for the first time to cool the turbomolecular pump stage directly by means of an electrically operated cooling device in order thus to counteract the above-described desorption and/or permeation problem already in the high vacuum range of the turbomolecular vacuum pump.

Preferred embodiments of the invention will now be looked at in the following. Further embodiments can also result from the dependent claims, from the description of the Figures and from the drawings themselves.

Thus, it can be provided according to an embodiment that the first pump mechanism has, as in a split-flow pump, a first turbomolecular pump stage and downstream thereof at least a second turbomolecular pump stage. In this case, it can be provided that the at least one electrically operated cooling device is located in the axial direction with respect to the at least second turbomolecular pump stage on the side of the at least second turbomolecular pump stage that faces the first turbomolecular pump stage. The at least one electrically operated cooling device is therefore located closer in the axial direction to the first turbomolecular pump stage than the Holweck pump stage and thus closer to the pump inlet than the Holweck pump stage. For example, the achievable final pressure decreases increasingly in the direction of the pump inlet so that it is advantageous for the reduction of gas desorption or gas permeation to arrange the at least one electrically operated cooling device as close as possible to the (single) pump inlet since the achievable final pressure is the lowest there and the gas desorption tendency or gas permeation tendency thus has the greatest influence on the pressure adopted.

Accordingly, in a split-flow pump having a first pump inlet and at least a second pump inlet, which is disposed in the axial direction between the first turbomolecular pump stage and the second turbomolecular pump stage, it may be suitable to arrange the at least one electrically operated cooling device in the axial direction such that it is disposed with respect to the second pump inlet on the side of the second pump inlet that faces the first pump inlet. The at least one electrically operated cooling device is therefore located even closer to the pump inlet that is disposed the furthest upstream in the direction of flow and that is also referred to throughout as the first pump inlet here since the gas permeation tendency or gas desorption tendency increases with increasing proximity to the first pump inlet.

If a split-flow pump has a third turbomolecular pump stage in the axial direction between the first turbomolecular pump stage and the second turbomolecular pump stage, in order to further reduce the gas desorption tendency or gas permeation tendency, it may be suitable according to a further embodiment to place the at least one electrically operated cooling device in the axial direction such that it is located with respect to the third turbomolecular pump stage on the side of the third turbomolecular pump stage that faces the first pump inlet or on the side of the third turbomolecular pump stage that faces first turbomolecular pump stage. Unlike in the previously described embodiment, the at least one electrically operated cooling device is thus located even closer to the pump inlet that is located the furthest upstream and that is also referred to as the first pump inlet here.

If a split-flow pump comprises a third pump inlet in the axial direction between the first turbomolecular pump stage and the third turbomolecular pump stage, in order to further reduce undesirable gas desorption phenomena and/or gas permeation phenomena, it may be suitable to arrange the at least one electrically operated cooling device in the axial direction such that it is disposed with respect to the third pump inlet on the side of the third pump inlet that faces the first pump inlet or on the side of the third pump inlet that faces the first turbomolecular pump mechanism.

In this respect, the pump inlets in question can all open radially into the interior of the housing; alternatively thereto, all the pump inlets except for the first pump inlet or the pump inlet disposed the furthest upstream can open radially into the interior of the housing, whereas the pump inlet disposed the furthest upstream or the first pump inlet opens axially into the interior of the housing at the head end of the housing that is disposed opposite the second pump mechanism.

To be able to reduce the gas desorption tendency or gas permeation tendency particularly effectively, it can be provided according to a preferred embodiment that the at least one electrically operated cooling device is located in the axial direction with respect to the first pump mechanism on the side of the first pump mechanism that faces the first pump inlet. The at least one electrically operated cooling device is therefore located in that region which is most susceptible to gas desorption phenomena and/or gas permeation phenomena since, in particular in the case of highly efficient split-flow pumps having a plurality of pump inlets and a plurality of turbomolecular pump stages, the lowest final pressure prevails in the region of the pump inlet disposed the furthest upstream.

Therefore, the at least one electrically operated cooling device is preferably located in the axial direction of the turbomolecular vacuum pump in a region in which a final pressure, which is to be positioned in the ultra-high vacuum range, is adopted in the interior of the turbomolecular vacuum pump during the operation, wherein the final pressure that is adopted is preferably less than 10⁻⁸ mbar, in particular less than 10⁻⁹ mbar, and in particular preferably less than 10⁻¹⁰ mbar.

Where reference is made here to at least one electrically operated cooling device, each cooling device can here be a fan that generates an air flow. According to an embodiment, said fan can be oriented such that the air flow generated by the fan impacts the housing, for example the already previously mentioned head end of the housing, in a radial direction or in an axial direction. Alternatively thereto, at least one fan can be oriented such that the air flow generated by it brushes the housing in a radial direction or in an axial direction while forming a boundary layer flow. The generated air flow therefore either extends parallel to the rotor shaft without impacting the head end of the housing in the process or extends perpendicular to said rotor shaft, wherein the air flow generates a turbulent boundary layer flow along the head end of the housing.

To intensify the cooling effect produced by the at least one fan, it can be provided according to a further embodiment that the housing of the turbomolecular vacuum pump has at least one heat sink that preferably comprises a plurality of cooling fins, wherein the heat sink is exposed to the air flow generated by the at least one fan.

According to different embodiments, it can furthermore be provided that at least one fan is directly fastened to the housing. In addition or alternatively thereto, it can be provided that at least one fan is indirectly fastened to the housing, for example, by means of a spacer device that is in turn fastened to the housing and that supports the at least one fan. Furthermore, in addition or as an alternative to the two types of fastening described above, in which the fan is directly or indirectly fastened to the housing, it can be provided according to a further embodiment that at least one fan is fastened to a support structure of a pumping station that is independent of the housing so that the fan can be oriented as required in order to cool different regions of the housing depending on the orientation.

In addition or as an alternative to the embodiments described above, in which the at least one electrically operated cooling device comprises at least one fan, it can be provided according to a further embodiment that the at least one electrically operated cooling device comprises at least one Peltier element. In this respect, it can be provided according to an embodiment that the at least one Peltier element is directly fastened to the outer side of the housing. In addition or alternatively thereto, it can be provided according to a further embodiment that the at least one Peltier element is integrated into the wall of the housing.

Thus, the housing can, for example, have at least one blind bore that receives at least one Peltier element. In this respect, it can preferably be provided that the housing has a plurality of blind bores that extend axially into the interior of the housing wall, starting from the head end of the housing that is disposed opposite the second pump mechanism, and that each receive at least one Peltier element.

The accommodation of the Peltier elements in question in the aforementioned blind bores is in particular suitable since such blind bores can already be present in conventional split-flow pumps anyway in order to receive heating rods. The pump can be heated by means of these heating rods during the initial putting into operation at the factory in order thus to ensure in advance that gas molecules are released by desorption from surfaces in the interior of the pump so that a large part of the gas desorption is so-to-say already anticipated in advance. Since the blind bores in question may thus already be present anyway, they can be used to receive Peltier elements after the initial putting into operation of the pump so that no additional receivers have to be provided in the housing wall for this purpose. Preferably, it can in this respect be suitable to provide the Peltier elements at the same holder that already carries the heating rods.

The invention will be described in the following by way of example with reference to advantageous embodiments and to the enclosed Figures. There are shown, schematically in each case:

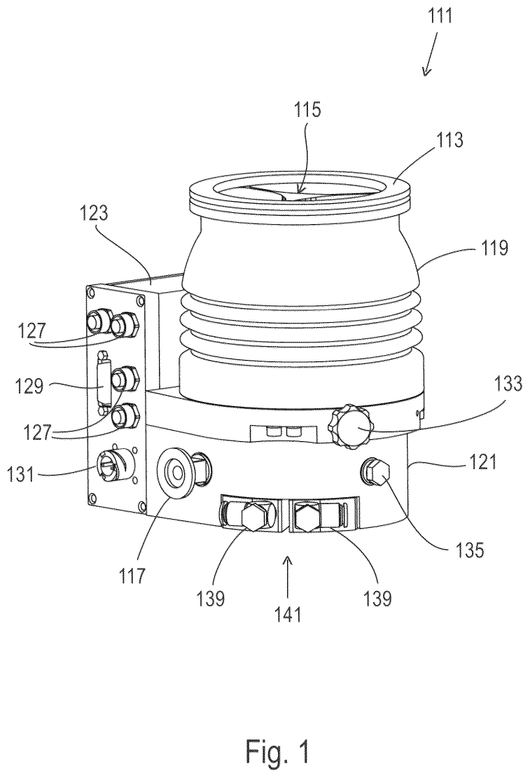

FIG. 1 a perspective view of a turbomolecular pump;

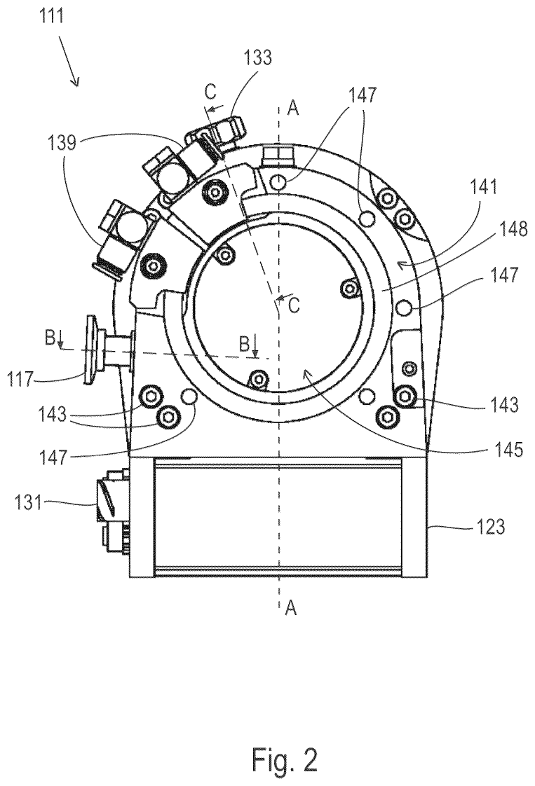

FIG. 2 a view of the lower side of the turbomolecular pump of FIG. 1;

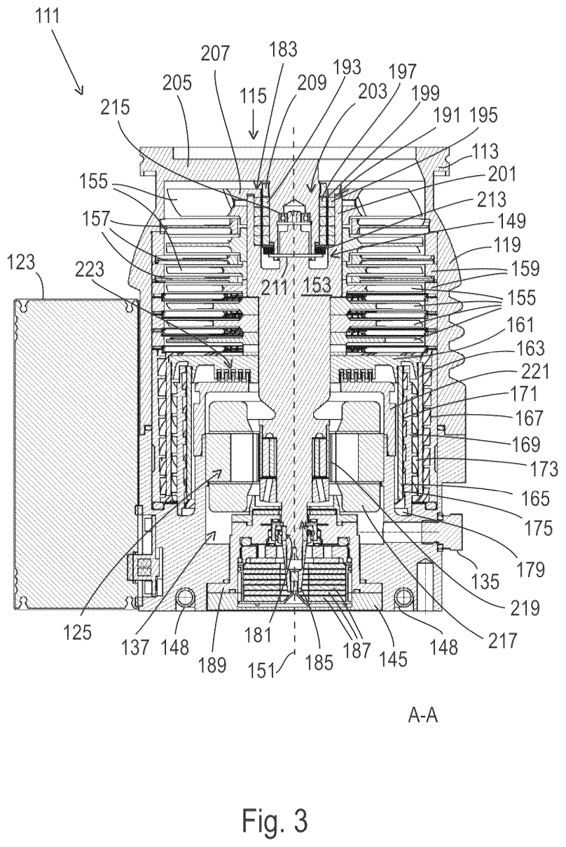

FIG. 3 a cross-section of the turbomolecular pump along the line A-A shown in FIG. 2;

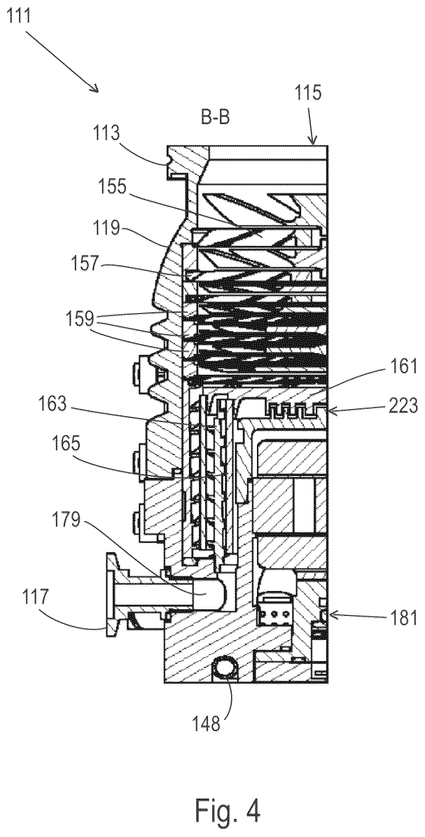

FIG. 4 a cross-sectional view of the turbomolecular pump along the line B-B shown in FIG. 2;

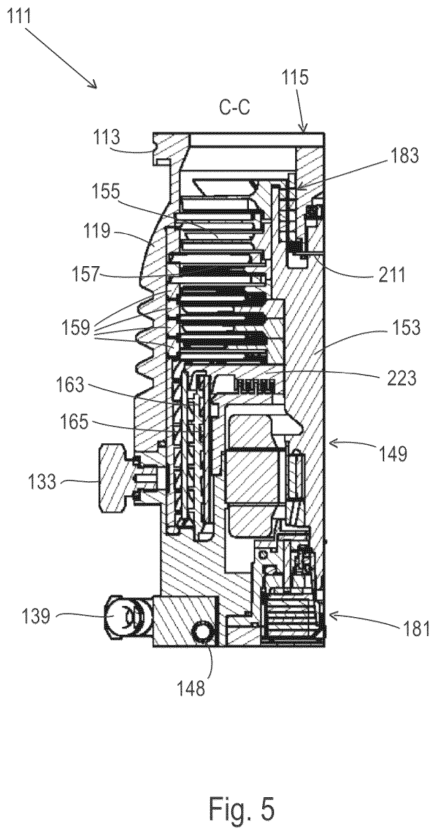

FIG. 5 a cross-sectional view of the turbomolecular pump along the line C-C shown in FIG. 2;

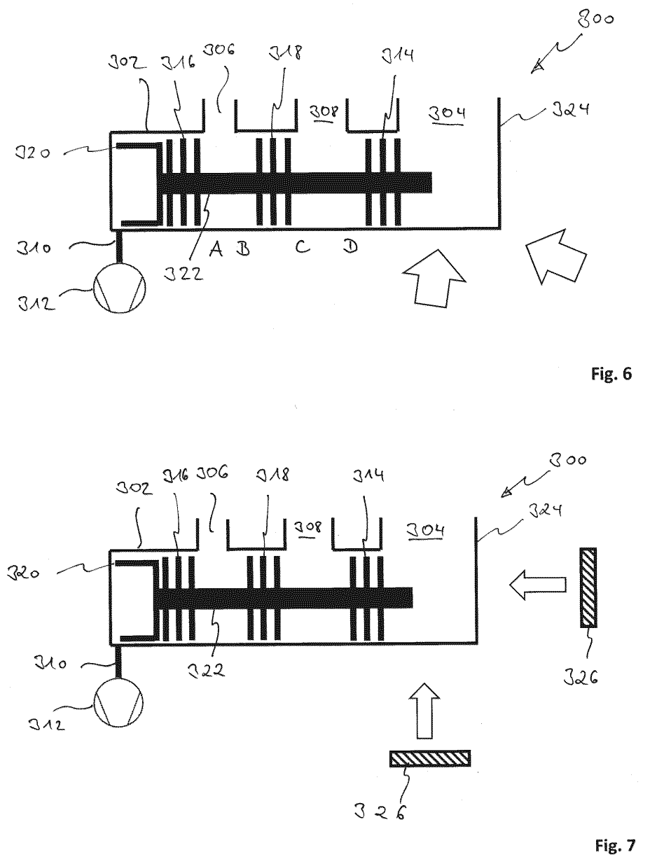

FIG. 6 a schematic representation of a split-flow pump with three pump inlets and three turbomolecular pump stages;

FIG. 7 a first embodiment of a pump system with the split-flow pump of FIG. 6 and two fans;

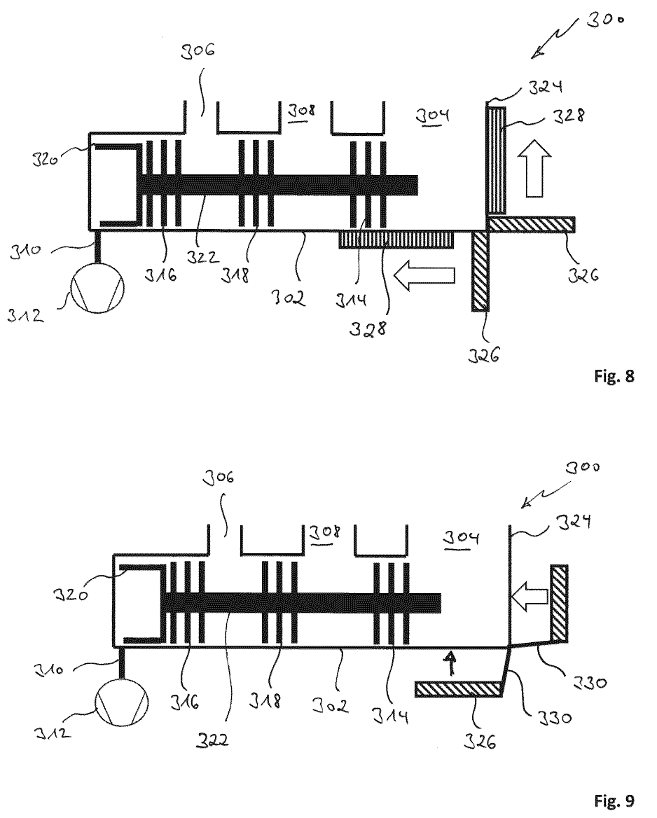

FIG. 8 a second embodiment of a pump system with the split-flow pump of FIG. 6 and two fans and two heat sinks;

FIG. 9 a third embodiment of a pump system with the split-flow pump of FIG. 6 and two fans;

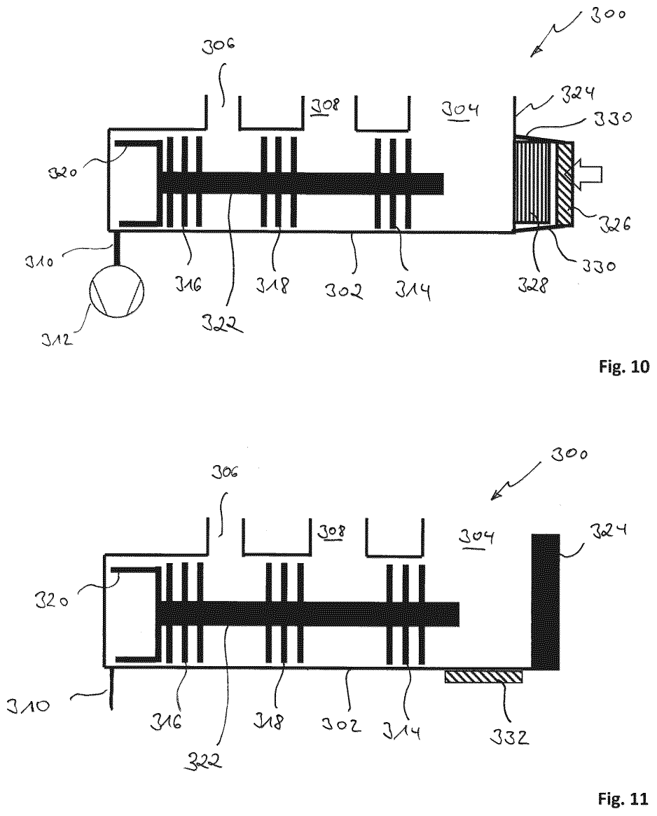

FIG. 10 a fourth embodiment of a pump system with the split-flow pump of FIG. 6, a fan and a heat sink;

FIG. 11 a fifth embodiment of a pump system with the split-flow pump of FIG. 6 and a Peltier element provided thereat;

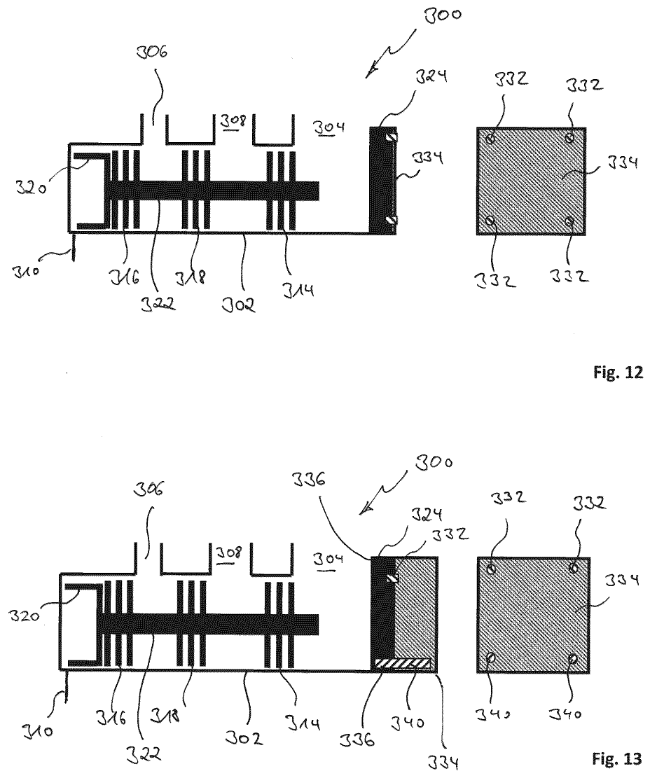

FIG. 12 a sixth embodiment of a pump system with the split-flow pump of FIG. 6 and a plurality of Peltier elements provided at a holder; and

FIG. 13 a seventh embodiment of a pump system with the split-flow pump of FIG. 6 and Peltier elements and heating elements provided at a holder.

The turbomolecular pump 111 shown in FIG. 1 comprises a pump inlet 115 which is surrounded by an inlet flange 113 and to which a recipient, not shown, can be connected in a manner known per se. The gas from the recipient can be sucked out of the recipient via the pump inlet 115 and can be conveyed through the pump to a pump outlet 117 to which a backing pump, such as a rotary vane pump, can be connected.

In the orientation of the vacuum pump in accordance with FIG. 1, the inlet flange 113 forms the upper end of the housing 119 of the vacuum pump 111. The housing 119 comprises a lower part 121 at which an electronics housing 123 is laterally arranged. Electrical and/or electronic components of the vacuum pump 111 are accommodated in the electronics housing 123, e.g. to operate an electric motor 125 (cf. also FIG. 3) arranged in the vacuum pump. A plurality of connections 127 for accessories are provided at the electronics housing 123. Furthermore, a data interface 129, e.g. in accordance with the RS485 standard, and a power supply connection 131 are arranged at the electronics housing 123. Turbomolecular pumps also exist that do not have such an attached electronics housing, but are connected to external drive electronics.

A flood inlet 133, in particular in the form of a flood valve, via which the vacuum pump 111 can be flooded, is provided at the housing 119 of the turbomolecular pump 111. In the region of the lower part 121, a barrier gas connection 135 is furthermore arranged which is also called a purge gas connection and via which purge gas can be let into the motor space 137, in which the electric motor 125 is accommodated in the vacuum pump 111, to protect the electric motor 125 (see e.g. FIG. 3) from the gas conveyed by the pump. Furthermore, two coolant connections 139 are also arranged in the lower part 121, with one of the coolant connections being provided as an inlet and the other coolant connection being provided as an outlet for coolant which can be conducted into the vacuum pump for cooling purposes. Other existing turbomolecular vacuum pumps (not shown) are operated with air cooling only.

The lower side 141 of the vacuum pump can serve as a standing surface so that the vacuum pump 111 can be operated standing up on the lower side 141. The vacuum pump 111 can, however, also be fastened to a recipient via the inlet flange 113 and can thus so-to-say be operated in a suspended manner. Furthermore, the vacuum pump 111 can be designed such that it can also be put into operation when it is oriented in a different manner than shown in FIG. 1.

Embodiments of the vacuum pump can also be implemented in which the lower side 141 can be arranged not directed downwardly, but rather facing to the side or directed upwardly. Any desired angles are generally possible in this respect.

Other existing turbomolecular vacuum pumps (not shown), which are in particular larger than the pump shown here, cannot be operated standing up.

Various screws 143 by means of which components of the vacuum pump that are not further specified here are fastened to one another are arranged at the lower side 141 that is shown in FIG. 2. A bearing cover 145 is, for example, fastened to the lower side 141.

Furthermore, fastening bores 147 via which the pump 111 can, for example, be fastened to a support surface are arranged at the lower side 141. This is not possible with other existing turbomolecular vacuum pumps (not shown) that are in particular larger than the pump shown here.

A coolant line 148 is shown in FIGS. 2 to 5 in which the coolant led in and out via the coolant connections 139 can circulate.

As the cross-sectional representations of FIGS. 3 to 5 show, the vacuum pump comprises a plurality of process gas pump stages for conveying the process gas present at the pump inlet 115 to the pump outlet 117.

A rotor 149 is arranged in the housing 119 and has a rotor shaft 153 rotatable about an axis of rotation 151.

The turbomolecular pump 111 comprises a plurality of turbomolecular pump stages connected to one another in series in a pump-active manner and having a plurality of radial rotor disks 155 fastened to the rotor shaft 153 and a plurality of stator disks 157 arranged between the rotor disks 155 and fixed in the housing 119. In this respect, a rotor disk 155 and an adjacent stator disk 157 each form a turbomolecular pump stage. The stator disks 157 are held by spacer rings 159 at a desired axial spacing from one another.

The vacuum pump furthermore comprises Holweck pump stages arranged in one another in a radial direction and connected to one another in series in a pump-active manner. Other turbomolecular vacuum pumps (not shown) exist that do not have Holweck pump stages.

The rotor of the Holweck pump stages comprises a rotor hub 161 arranged at the rotor shaft 153 and two Holweck rotor sleeves 163, 165 of cylinder jacket shape that are fastened to the rotor hub 161 and supported by it, that are oriented coaxially to the axis of rotation 151, and that are nested in one another in the radial direction. Furthermore, two Holweck stator sleeves 167, 169 of cylinder jacket shape are provided that are likewise oriented coaxially to the axis of rotation 151 and that are nested in one another in the radial direction.

The pump-active surfaces of the Holweck pump stages are formed by the jacket surfaces, i.e. by the radial inner surfaces and/or outer surfaces, of the Holweck rotor sleeves 163, 165 and of the Holweck stator sleeves 167, 169. The radial inner surface of the outer Holweck stator sleeve 167 is disposed opposite the radial outer surface of the outer Holweck rotor sleeve 163 while forming a radial Holweck gap 171 and forms the first Holweck pump stage following the turbomolecular pumps together with said radial outer surface. The radial inner surface of the outer Holweck rotor sleeve 163 is disposed opposite the radial outer surface of the inner Holweck stator sleeve 169 while forming a radial Holweck gap 173 and forms a second Holweck pump stage together with said radial outer surface. The radial inner surface of the inner Holweck stator sleeve 169 is disposed opposite the radial outer surface of the inner Holweck rotor sleeve 165 while forming a radial Holweck gap 175 and forms the third Holweck pump stage together with said radial outer surface.

A radially extending passage via which the radially outwardly disposed Holweck gap 171 is connected to the middle Holweck gap 173 can be provided at the lower end of the Holweck rotor sleeve 163. Furthermore, a radially extending passage via which the middle Holweck gap 173 is connected to the radially inwardly disposed Holweck gap 175 can be provided at the upper end of the inner Holweck stator sleeve 169. The Holweck pump stages nested in one another are thereby connected to one another in series. A connection passage 179 to the outlet 117 can furthermore be provided at the lower end of the radially inwardly disposed Holweck rotor sleeve 165.

The above-named pump-active surfaces of the Holweck stator sleeves 167, 169 each have a plurality of Holweck grooves extending in the axial direction in a spiral shape about the axis of rotation 151 while the oppositely disposed jacket surfaces of the Holweck rotor sleeves 163, 165 are smooth and advance the gas for operating the vacuum pump 111 into the Holweck grooves.

For the rotatable support of the rotor shaft 15, a rolling element bearing 181 is provided in the region of the pump outlet 117 and a permanent magnet bearing 183 is provided in the region of the pump inlet 115.

In the region of the rolling element bearing 181, a conical splash nut 185 having an outer diameter increasing toward the rolling element bearing 181 is provided at the rotor shaft 153. The splash nut 185 is in sliding contact with at least one wiper of an operating medium store. In other existing turbomolecular vacuum pumps (not shown), an injection screw can be provided instead of a splash nut. Since different designs are thus possible, the term “spray tip” is also used in this connection.

The operating medium store comprises a plurality of absorbent disks 187 which are stacked on top of one another and which are saturated with an operating medium for the rolling element bearing 181, e.g. with a lubricant.

In the operation of the vacuum pump 111, the operating medium is transferred by capillary effect from the operating medium store via the wiper to the rotating splash nut 185 and is conveyed as a consequence of the centrifugal force along the splash nut 185 in the direction of the outer diameter, which is becoming larger, of the splash nut 185 to the rolling element bearing 181, where it e.g. satisfies a lubricating function. The rolling element bearing 181 and the operating medium store are encompassed by a tub-shaped insert 189 and the bearing cover 145 in the vacuum pump.

The permanent magnet bearing 183 comprises a rotor-side bearing half 191 and a stator-side bearing half 193 that each comprise a ring stack of a plurality of permanent magnetic rings 195, 197 stacked on top of one another in the axial direction. The ring magnets 195, 197 are disposed opposite one another while forming a radial bearing gap 199, with the rotor-side ring magnets 195 being arranged radially outwardly and the stator-side ring magnets 197 being arranged radially inwardly. The magnetic field present in the bearing gap 199 produces magnetic repulsion forces between the ring magnets 195, 197 that effect a radial support of the rotor shaft 153. The rotor-side ring magnets 195 are carried by a carrier section 201 of the rotor shaft 153 that surrounds the ring magnets 195 at the radial outer side. The stator-side ring magnets 197 are carried by a stator-side carrier section 203 that extends through the ring magnets 197 and that is suspended at radial struts 205 of the housing 119. The rotor-side ring magnets 195 are fixed in parallel with the axis of rotation 151 by a cover element 207 coupled to the carrier section 201. The stator-side ring magnets 197 are fixed in parallel with the axis of rotation 151 in the one direction by a fastening ring 209 connected to the carrier section 203 and by a fastening ring 211 connected to the carrier section 203. A plate spring 213 can furthermore be provided between the fastening ring 211 and the ring magnets 197.

An emergency bearing or safety bearing 215 is provided within the magnetic bearing; it idles in the normal operation of the vacuum pump 111 without contact and only moves into engagement on an excessive radial deflection of the rotor 149 relative to the stator to form a radial abutment for the rotor 149 so that a collision of the rotor-side structures with the stator-side structures is prevented. The safety bearing 215 is configured as a non-lubricated rolling element bearing and forms a radial gap with the rotor 149 and/or the stator, said radial gap having the effect that the safety bearing 215 is out of engagement in normal pump operation. The radial deflection during which the safety bearing 215 enters into engagement is dimensioned sufficiently large so that the safety bearing 215 does not move into engagement in the normal operation of the vacuum pump and is simultaneously small enough so that a collision of the rotor-side structures with the stator-side structures is avoided under all circumstances.

The vacuum pump 111 comprises the electric motor 125 for a rotating driving of the rotor 149. The armature of the electric motor 125 is formed by the rotor 149 whose rotor shaft 153 extends through the motor stator 217. A permanent magnet arrangement can be arranged at the radial outer side or in an embedded manner on the section of the rotor shaft 153 that extends through the motor stator 217. An intermediate space 219 that comprises a radial motor gap, via which the motor stator 217 and the permanent magnet arrangement 128 can magnetically influence one another to transmit the drive torque, is arranged between the motor stator 217 and the section of the rotor 149 that extends through the motor stator 217.

The motor stator 217 is fixed in the housing within the motor space 137 provided for the electric motor 125. A barrier gas, which is also called a purge gas and which can, for example, be air or nitrogen, can enter the motor space 137 via the barrier gas connection 135. The electric motor 125 can be protected from process gas, e.g. from corrosively active portions of the process gas, via the barrier gas. The motor space 137 can also be evacuated via the pump outlet 117, i.e. the vacuum pressure effected by the backing pump connected to the pump outlet 117 is at least approximately present in the motor space 137.

Furthermore, a so-called labyrinth seal 223 that is known per se can be provided between the rotor hub 161 and a wall 221 bounding the motor space 137, in particular to achieve a better sealing of the motor space 217 with respect to the Holweck pump stages disposed radially outside.

After the basic structure of a turbomolecular vacuum pump 111 has been explained above with reference to FIGS. 1 to 5, the structure of a turbomolecular vacuum pump 300 configured as a split-flow pump will be explained below with reference to FIG. 6 and the cooling concept according to the invention will then be explained below with reference to said turbomolecular vacuum pump 300 and to FIG. 7 ff. However, this cooling concept can be applied in a corresponding manner to the turbomolecular vacuum pump 111 described above with reference to FIGS. 1 to 5.

Since the basic structure of the turbomolecular vacuum pump 300 shown in FIG. 6 corresponds to that of the turbomolecular vacuum pump 111 described with reference to FIGS. 1 to 5, the description of the turbomolecular vacuum pump 300 is limited to the main differences from the turbomolecular vacuum pump 111 of FIGS. 1 to 5.

Similar to the turbomolecular vacuum pump 111, the turbomolecular vacuum pump 300 also has a housing 302 having a first pump inlet 304 and a pump outlet 310, wherein, however, unlike the pump inlet 115 of the turbomolecular vacuum pump 111 of FIGS. 1 to 5, the pump inlet 304 does not open axially, but rather opens radially, into the interior of the housing 302 here. A backing pump 312 is connected to the pump outlet 310 and discharges the process gas conveyed by the turbomolecular vacuum pump 300 from the pump inlet 304 to the pump outlet 310 into the environment.

The process gas is conveyed from the pump inlet 304 to the pump outlet 310 by means of three turbomolecular pump stages 314, 316, 318 and a downstream Holweck pump stage 320, all of which are arranged along a rotor shaft 322 and are driven by the latter. The first turbomolecular pump stage 314 is in this respect located closest to and downstream of the pump inlet 304. The third turbomolecular pump stage 318 is located downstream of the first turbomolecular pump stage 314, whereas the second turbomolecular pump stage 316 is again located downstream of the third turbomolecular pump stage 316. The third turbomolecular pump stage 318 is therefore located between the first and the second pump stage 314, 316.

As can be seen in FIG. 6, the three turbomolecular pump stages 314, 316, 318 are spaced apart from one another in the axial direction, wherein a second pump inlet 306 opens radially into the interior of the housing 302 at the spacing between the third turbomolecular pump stage 318 and the second turbomolecular pump stage 316, whereas a third pump inlet 308 opens radially into the housing interior at the spacing between the first turbomolecular pump stage 314 and the third turbomolecular pump stage 318.

As is already schematically indicated by the two arrows in FIG. 6, it is provided according to the invention in the split-flow pump 300 shown that the head end 324 of the housing 302, which is located at the head end 324 of the housing 302 disposed opposite the Holweck pump stage 302, is cooled by fans (not shown) that direct an air flow, illustrated by the arrows shown, to the housing 302. In the embodiment illustrated here, the fan or fans are provided at the head end 324 of the housing 302 since the lowest pressure prevails upstream of the first turbomolecular pump stage 314 or in the region of the first pump inlet 304 during the pump operation and the gas desorption there contributes to a non-negligible pressure increase. In principle, however, in the region of the entire turbomolecular pump mechanism, which is formed by the three turbomolecular pump stages 314, 316, 318, due to the low pressures prevailing there during the pump operation, there is an increased gas desorption tendency so that, if required, it may also be suitable to cool the housing 302 in the area of the regions marked “A”, “B”, “C” and “D” in FIG. 6.

In this respect, the region “A” is located with respect to the second turbomolecular pump stage 316 on the side of the second turbomolecular pump stage 316 that faces the first turbomolecular pump stage 314. The second region “B” is located in the axial direction with respect to the second pump inlet 306 on the side of the second pump inlet 306 that faces the first pump inlet 304. The third region “C” is located in the axial direction with respect to the third turbomolecular pump stage 318 on the side of the third turbomolecular pump stage 318 that faces the first pump inlet 304. Finally, the fourth region “D” is located in the axial direction with respect to the third pump inlet 308 on the side of the third pump inlet 308 that faces the first pump inlet 304.

In principle, however, it has proven to be advantageous to cool all those regions by means of an electrically operated cooling device in which a pressure, which is in the ultra-high vacuum range, is adopted in the interior of the turbomolecular vacuum pump 300 during the operation. The regions are in particular regions in which a pressure of less than 10⁻⁹ mbar, and in particular of less than 10⁻¹⁰ mbar, prevails.

In the pump system described with reference to FIG. 7, the housing region upstream of the first turbomolecular pump stage 314 is cooled by means of two only schematically illustrated fans 326, wherein the one fan 326 is oriented such that the air flow generated by it impacts the housing 302 in a radial direction, whereas the other fan 326 is oriented such that the air flow generated by it impacts the housing 302, and in particular the head end 324 of the housing 302 disposed opposite the Holweck pump stage 320, in an axial direction. If required, the pump system can also have further fans 326 that are oriented so that their air flow impacts the housing 302 in a radial direction in one or more of the regions “A”, “B”, “C” and/or “D”, see in this respect FIG. 6. In the embodiment of FIG. 7, the fans 326 are not fastened to the housing 302 itself, but to a support structure (not shown) independent of the housing 302, for example, a pumping station or a mass spectrometer in which the split flow can be installed, which makes it possible to arrange and orient the fans 326 as required.

In contrast to the embodiment of FIG. 7, in the embodiment of the pump system of FIG. 8, the two fans 326 are directly fastened to the housing 302, wherein both fans 326 are oriented such that the air flow generated by them brushes the housing 302 in a radial direction or an axial direction. Two fans 326 are indeed provided in the embodiment shown here, but it may also be sufficient to cool only the head end 324 of the housing 302 with one fan 326.

To improve the cooling effect produced by the fans 326, it is further provided in the embodiment of FIG. 8 that each fan 326 is assigned a heat sink 328 having preferably a plurality of cooling fins, wherein the respective heat sink 328 is positioned at the housing 302 such that it is exposed to the air flow that is generated by the fan 326 associated with the respective heat sink 328.

In contrast to the embodiment of FIG. 8, in the embodiment of the pump system of FIG. 9, the two fans 326 are not, for instance, directly fastened to the housing 302, but indirectly with the aid of suitable spacer devices 330, wherein, unlike the embodiment of FIG. 8, the fans 326 are oriented such that the air flow generated by each of them directly impacts the housing 302 in the radial or axial direction.

In the embodiment of FIG. 10, the head end 324 of the housing 302 is also cooled by means of a fan 326 that is fastened to the housing 302 via a spacer device 330 and that is also oriented in this embodiment such that the air flow generated by said fan 326 directly impacts the housing 302, and in particular the head end 324 of the housing 302, in the axial direction. In this respect, a heat sink 328 having a plurality of cooling fins is located at a spacing between the fan 326 and the head end 324 of the housing 302 and is fastened to the housing 302 in order thus to increase the cooling effect produced by the fan 326.

In the embodiment of FIG. 11, the electrically operated cooling device is not, for instance, formed by a fan, but by a Peltier element 332 that is fastened there purely by way of example to the outer periphery of the housing 302 in a region that is located upstream of the first turbomolecular pump stage 314. In addition or alternatively thereto, Peltier elements can, however, also be provided in the regions “A”, “B”, “C” and/or “D” (see FIG. 6 in this respect) at the housing 302 in order thus to additionally or alternatively cool these regions as well.

In the embodiment of FIG. 12, the head end 324 of the housing 302 is cooled by four Peltier elements 332. The Peltier elements 332 are in this respect fastened to a holder 334 and extend into respective blind bores 336 that are formed in the head end 324 of the housing 302.

In the embodiment of FIG. 13, it is ultimately provided that the holder 334 carries not only two Peltier elements 332, but also two heating elements 340, wherein both the Peltier elements 332 and the heating elements 340 extend into blind bores 336 formed in the head end 324 of the housing 302. By means of the heating elements 340, the pump can in this respect be heated during the initial putting into operation at the factory in order thus to ensure in advance that gas molecules are released by desorption from surfaces in the interior of the pump so that a large part of the gas desorption is so-to-say already anticipated in advance. The Peltier elements 332, on the other hand, serve to cool the turbomolecular vacuum pump 300, as in the embodiment of FIG. 12, in order thus to limit the gas desorption during the operation of said turbomolecular vacuum pump 300.

For the sake of good order, it should be noted at this point that specific arrangements of electrically operated cooling devices have been explained with reference to FIGS. 7 to 13; however, as already noted in part above, the respective cooling devices can also be arranged and oriented as required in order to cool one or more of the regions “A”, “B”, “C” and/or “D” as well.

### REFERENCE NUMERAL LIST

111 turbomolecular pump
113 inlet flange
115 pump inlet
117 pump outlet
119 housing
121 lower part
123 electronics housing
125 electric motor
127 accessory connection
129 data interface
131 power supply connection
133 flood inlet
135 barrier gas connection
137 motor space
139 coolant connection
141 lower side
143 screw
145 bearing cover
147 fastening bore
148 coolant line
149 rotor
151 axis of rotation
153 rotor shaft
155 rotor disk
157 stator disk
159 spacer ring
161 rotor hub
163 Holweck rotor sleeve
165 Holweck rotor sleeve
167 Holweck stator sleeve
169 Holweck stator sleeve
171 Holweck gap
173 Holweck gap
175 Holweck gap
179 connection passage
181 rolling element bearing
183 permanent magnet bearing
185 splash nut
187 disk
189 insert
191 rotor-side bearing half
193 stator-side bearing half
195 ring magnet
197 ring magnet
199 bearing gap
201 carrier section
203 carrier section
205 radial strut
207 cover element
209 support ring
211 fastening ring
213 plate spring
215 emergency bearing or safety bearing
217 motor stator
219 intermediate space
221 wall
223 labyrinth seal
300 turbomolecular vacuum pump
302 housing
304 first pump inlet
306 second pump inlet
308 third pump inlet
310 pump outlet
312 backing pump
314 first turbomolecular pump stage
316 second turbomolecular pump stage
318 third turbomolecular pump stage
320 Holweck pump stage
322 rotor shaft
324 head end
326 fan
328 heat sink
330 spacer device
332 Peltier element
334 holder
336 blind bore
340 heating element

1-16. (canceled)

17. A pump system comprising a turbomolecular vacuum pump that comprises:
a housing having at least one pump inlet and one pump outlet;
a first pump mechanism, which is driven by a rotor shaft and which has at least one turbomolecular pump stage, in the housing; and
a second pump mechanism, which is located downstream of the first pump mechanism and which is driven by the rotor shaft, in the housing, said second pump mechanism operating according to a different pumping principle than the first pump mechanism,
wherein, for jointly conveying a process gas from the pump inlet to the pump outlet, the first pump mechanism and the second pump mechanism are arranged along the rotor shaft and are disposed in an axial direction between the at least one pump inlet and the pump outlet, and
wherein, to cool the housing, the pump system further comprises at least one electrically operated cooling device that is located in the axial direction with respect to the second pump mechanism on a side of the second pump mechanism that faces the first pump mechanism.

18. The pump system according to claim 17,
wherein the first pump mechanism comprises a first turbomolecular pump stage and, downstream of the first turbomolecular pump stage, at least a second turbomolecular pump stage, and
wherein the at least one electrically operated cooling device is located in the axial direction with respect to the at least second turbomolecular pump stage on the side of the at least one second turbomolecular pump stage that faces the first turbomolecular pump stage.

19. The pump system according to claim 18,
wherein the housing has a first pump inlet and at least a second pump inlet that is disposed in the axial direction between the first turbomolecular pump stage and the second turbomolecular pump stage, and
wherein the at least one electrically operated cooling device is located in the axial direction with respect to the second pump inlet on the side of the second pump inlet that faces the first pump inlet.

20. The pump system according to claim 18,
wherein the first pump mechanism further comprises at least a third turbomolecular pump stage that is disposed in the axial direction between the first turbomolecular pump stage and the second turbomolecular pump stage, and
wherein the at least one electrically operated cooling device is located in the axial direction with respect to the third turbomolecular pump stage on the side of the third turbomolecular pump stage that faces the first pump inlet.

21. The pump system according to claim 20,
wherein the housing further has at least a third pump inlet that is disposed in the axial direction between the first turbomolecular pump stage and the third turbomolecular pump stage, and
wherein the at least one electrically operated cooling device is located in the axial direction with respect to the third pump inlet on the side of the third pump inlet that faces the first pump inlet.

22. The pump system according to claim 17,
wherein the at least one electrically operated cooling device is located in the axial direction with respect to the first pump mechanism on the side of the first pump mechanism that faces the first pump inlet.

23. The pump system according to claim 17,
wherein the at least one electrically operated cooling device is located in the axial direction of the turbomolecular vacuum pump in a region in which a final pressure, which is in an ultra-high vacuum range, is adopted in an interior of the turbomolecular vacuum pump during the operation.

24. The pump system according to claim 17,
wherein all the pump inlets open radially into an interior of the housing, or
wherein all the pump inlets except for the first pump inlet open radially into the interior of the housing, whereas the first pump inlet opens axially into the interior of the housing at a head end of the housing that is disposed opposite the second pump mechanism.

25. The pump system according to claim 17,
wherein the at least one electrically operated cooling device is at least one fan generating an air flow.

26. The pump system according to claim 25,
wherein the at least one fan is oriented such that the air flow generated by the at least one fan impacts the housing in a radial direction or in an axial direction.

27. The pump system according to claim 25,
wherein at least one fan is oriented such that the air flow generated by the at least one fan brushes the housing in a radial direction or in an axial direction while forming a boundary layer flow.

28. The pump system according to claim 25,
wherein the housing has at least one heat sink, and
wherein the heat sink is exposed to the air flow generated by the at least one fan.

29. The pump system according to claim 25,
wherein at least one fan is directly fastened to the housing.

30. The pump system according to claim 17,
wherein the at least one electrically operated cooling device is at least one Peltier element.

31. The pump system according to claim 30,
wherein the at least one Peltier element is fastened to an outer side of the housing.

32. The pump system according to claim 30,
wherein the housing has at least one blind bore that receives the at least one Peltier element.

33. The pump system according to claim 23,
wherein the final pressure that is adopted is less than 10-8 mbar.

34. The pump system according to claim 28,
wherein the at least one heat sink comprises a plurality of cooling fins.

35. The pump system according to claim 25,
wherein at least one fan is indirectly fastened to the housing.

36. The pump system according to claim 35,
wherein at least one fan is indirectly fastened to the housing by means of a spacer device.

37. The pump system according to claim 25,
wherein at least one fan is fastened to a support structure that is independent of the housing.

38. The pump system according to claim 32,
wherein the housing has a plurality of blind bores that extend axially into an interior of a housing wall, starting from a head end of the housing that is disposed opposite the second pump mechanism, and that each blind bore receive at least one Peltier element.
